(19) United States
(12) Patent Application Publication
(10) Pub. No.: US 2017/0271867 A1
(43) Pub. Date: Sep. 21, 2017

(54) INRUSH CURRENT PREVENTION CIRCUIT

(71) Applicant: FUJI ELECTRIC CO., LTD., Kawasaki-shi (JP)

(72) Inventor: Yoshitaka HAMADA, Yokohama (JP)

(73) Assignee: FUJI ELECTRIC CO., LTD., Kawasaki-shi (JP)

(21) Appl. No.: 15/611,458

(22) Filed: Jun. 1, 2017

Related U.S. Application Data
(63) Continuation of application No. PCT/JP2015/083689, filed on Dec. 1, 2015.

(51) Int. Cl. H02H 9/02; H02M 1/32

(52) U.S. Cl. CPC H02H 9/025; H02M 1/32

(57) ABSTRACT

An inrush current prevention circuit, according to one possible configuration, includes: a power supply input terminal; a high-resistance element to restrict an inrush current flowing in when a power supply voltage is applied to the power supply input terminal; a low-resistance bypass element connected in parallel with the high-resistance element and configured to operate so as to cause current to bypass the high-resistance element when an output voltage being output from the inrush current prevention circuit to a load exceeds a bypass threshold; and bypass threshold setting circuit that divides the power supply voltage in accordance with the output voltage, and sets the bypass threshold in accordance with a voltage value of a voltage dividing point of the bypass threshold setting circuit.

### CROSS-REFERENCE TO RELATED APPLICATIONS

This application is a continuation application, filed under 35 U.S.C. §111(a), of International Application PCT/JP2015/083689 filed on Dec. 1, 2015, the contents of which is incorporated herein by reference in its entirety.

### BACKGROUND

1. Field

The present disclosure relates to an inrush current prevention circuit that restricts an inrush current flowing when a power supply to an electronic circuit is turned on.

2. Related Art

When a power supply to an electronic circuit including a capacitor is turned on, a transiently extremely large current, that is, an inrush current, flows immediately afterward in order to charge the capacitor. When an excessive inrush current flows, there is concern that serious damage will be caused not only to the capacitor or a load, but also to the power supply.

Therefore, there is widespread awareness of an inrush current prevention circuit wherein an inrush current is restricted by a high-resistance element such as a current limiting resistor being inserted in an electrical circuit when a power supply is turned on, and the high-resistance element is bypassed using a low-resistance bypass element after the inrush current subsides, whereby unnecessary power consumption by the high-resistance element is suppressed.

The heretofore described inrush current prevention circuit is such that when bypassing using the bypass element before the inrush current subsides sufficiently, the inrush current flows again, because of which there is a demand for the timing at which the high-resistance element is bypassed to be appropriately controlled.

In order to determine whether or not the inrush current has subsided sufficiently, it is sufficient to detect a charging voltage of the capacitor. That is, provided that the charging voltage of the capacitor is detected, and a bypass operation caused to be carried out at a timing at which a value of the charging voltage exceeds a predetermined value, there is no concern that a large inrush current will flow in again.

An inrush current prevention circuit based on this kind of principle is described in, for example, JP-A-2009-261166 (paragraphs [0043] to [0049], FIG. 4 and the like) (“JP '166”).

FIG. 4 shows the inrush current prevention circuit described in JP '166.

In FIG. 4, 101 is a direct current power supply, 102 is a connector, 103 is an FET acting as a bypass element, 104 is a charging resistor (current limiting resistor) acting as a high-resistance element, 105 and 106 are voltage-dividing resistors, 107 and 109 are capacitors, 108 is a transistor that controls a gate voltage of the FET 103, 110 is a control circuit, 111 is a comparator, 112 is a reference power supply, 113 and 114 are output voltage dividing resistors, and 120 is a load.

This existing technology is such that when the connector 102 is connected and the power supply is turned on, the FET 103 is in an off-state (non-conductive), and a charging current (inrush current) that flows into the capacitor 109 flows via the charging resistor 104 until the capacitor 109 is sufficiently charged, because of which the inrush current is restricted.

When the capacitor 109 is eventually charged by the current restricted by the heretofore described operation, and a divided voltage value of the voltage-dividing resistors 113 and 114 exceeds a charging threshold (a reference voltage of the reference power supply 112), output of the comparator 111 is inverted, the transistor 108 and FET 103 switch to an on-state (conductive), and the charging resistor 104 is bypassed.

This existing technology is characterized in that a bypass operation by the FET 103 is executed by a divided voltage value corresponding to voltage of the capacitor 109 exceeding a charging threshold.

However, the circuit of FIG. 4 is such that the charging threshold of the reference power supply 112 needs to be uniquely set in accordance with a lower limit of a rated input voltage range, meaning that when the rated input voltage range of the circuit is wide, there is a problem in that an inrush current when the FET 103 switches from an off-state to an on-state cannot be sufficiently restricted.

For example, provided that the charging threshold is set in the region of 4.5V when the rated input voltage range is 5 to 6V, a potential difference across the charging resistor 104 (a drain-to-source voltage of the FET 103) when the FET 103 switches from an off-state to an on-state and the charging resistor 104 is bypassed is 1.5V, even when the input voltage is the maximum rated voltage of 6V, because of which it can be said that there is no occurrence of an excessive inrush current when the FET 103 switches to an on-state.

However, even when the rated input voltage range is, for example, 5 to 15V, the charging threshold has to be set in the region of 4.5V, meaning that when the input voltage is the maximum rated voltage of 15V, the drain-to-source voltage of the FET 103 when the FET 103 switches from an off-state to an on-state and the charging resistor 104 is bypassed is 10.5V, and there is a problem in that an excessive inrush current flows in via the FET 103.

Meanwhile, technology whereby a step-up power supply device, wherein direct current power supply voltage is stepped-up by a converter and output, is such that current flowing through a switching element of the step-up converter when input voltage is high is limited, thereby restricting an inrush current, is disclosed in JP-A-2008-79448 (paragraphs [0018] to [0029], FIG. 1, FIG. 2, and the like) (“JP '448”), corresponding to U.S. Pat. No. 7,567,069.

FIG. 5 is a circuit diagram of the step-up power supply device described in JP '448 wherein, at a start-up time when an output voltage Vₒ of a step-up converter 150 is equal to or less than a threshold Vᵣ of a comparator 161 (Vₒ≦Vᵣ), a low level output signal of the comparator 161 is inverted to a high level by an inverting circuit 162, and input into a start-up circuit 140. The start-up circuit 140 is such that an inrush current is restricted by an operation of an FET 151 being controlled via a drive circuit 142 so that a drain voltage Vₓ of the FET 151 inside the step-up converter 150 does not exceed a threshold Vₜₕ of a comparator 141.

Also, when Vₒ>Vᵣ, a high level output signal of the comparator 161 is input into a control circuit 164 via a delay circuit 163, because of which the control circuit 164 controls the operation of the FET 151 in place of the start-up circuit 140.

This existing technology is such that when the voltage of a direct current power supply 131 is high, and a period for which the drain voltage Vₓ of the FET 151 exceeds the threshold Vₜₕ of the comparator 141 is long, an operation is such that a gate pulse sent from the start-up circuit 140 to the FET 151 becomes shorter, whereby an excessive current is prevented from flowing into the FET 151.

Also, a load control device wherein an inrush current flowing into a fuel injection device electromagnetic valve is restricted is described in JP-A-2005-158870 (paragraphs [0055] to [0067], FIG. 1 to FIG. 5, and the like) (“JP '870”). FIG. 6 is a circuit diagram showing this existing technology.

In FIG. 6, a processing circuit 180 controls a voltage dividing control switch 173 so as to increase an input voltage of a load input terminal of a comparator 174 for a certain period W1 when starting up an electromagnetic valve 190, and reduce the input voltage in a subsequent holding period W2, and operates so as to turn on a drive switching element 177 throughout the periods W1 and W2. 171 is a direct current power supply, and 172 is a voltage dividing resistor.

An output of a load current detecting circuit 178 is input into a positive input terminal of the comparator 174, and the comparator 174 outputs an instruction signal in accordance with a magnitude relationship of a negative input terminal voltage to a control circuit 175. The control circuit 175 operates so as to turn on a duty control switching element 176 in the period W1 and turn off the switching element 176 in the period W2, limits a load current I_{L} in the period W1 to a third current value equal to or smaller than a first current value, and limits the load current I_{L} in the holding period W2 to a second current value, which is equal to or smaller than the third current value and the minimum necessary for driving the electromagnetic valve 190.

### SUMMARY

According to the existing technology described in JP '448, an inrush current when starting up can be restricted, but because of the principle of causing one of the start-up circuit 140 or control circuit 163 to operate, a circuit utilization rate is low, which is wasteful in terms of circuit configuration and cost.

Also, the existing technology described in JP '870 is such that a large current (the third current value) flows in the period W1 when starting up, because of which, despite the period W1 being a short period, there is still room for improvement in terms of restricting inrush current.

Therefore, this disclosure provides an inrush current prevention circuit wherein an inrush current when turning on a power supply can be reliably restricted, regardless of a rated input voltage range, using a comparatively simple circuit configuration.

In order to achieve the benefits mentioned in the above paragraph, a first aspect of this disclosure is an inrush current prevention circuit wherein an inrush current flowing in when a power supply voltage is applied to a power supply input terminal is restricted by a high-resistance element, and the high-resistance element is bypassed by causing a low-resistance bypass element connected in parallel with the high-resistance element to operate when an output voltage to a load exceeds a bypass threshold, the inrush current prevention circuit including bypass threshold setting circuit or means that divides the power supply voltage in accordance with the output voltage, and sets the bypass threshold in accordance with a voltage value of a voltage dividing point thereof.

According to a second aspect of the disclosure, the inrush current prevention circuit according to the first aspect is such that the bypass threshold setting circuit or means includes a first comparator that compares a value corresponding to the output voltage to the load and a first threshold, a first switching element that operates in accordance with an output signal of the first comparator when the output voltage corresponding value exceeds the first threshold, and a voltage dividing circuit that divides the power supply voltage in accordance with an operation of the first switching element, wherein a voltage value of a voltage dividing point in the voltage dividing circuit is set as the bypass threshold when the output voltage corresponding value exceeds the first threshold.

According to a third aspect of the disclosure, the inrush current prevention circuit according to the second aspect is such that the output voltage corresponding value is a voltage resulting from the output voltage to the load being divided, and the first threshold is set in accordance with a lower limit value of a rated input voltage range.

According to a fourth aspect of the disclosure, the inrush current prevention circuit according to the second or third aspects is such that the first threshold is set lower than a minimum operating voltage of the load.

According to a fifth aspect of the disclosure, the inrush current prevention circuit according to any one of the second through fourth aspects includes a second comparator that compares the output voltage to the load and the bypass threshold, and a second switching element that operates in accordance with an output signal of the second comparator when the output voltage exceeds the bypass threshold, wherein the bypass element bypasses the high-resistance element in accordance with an operation of the second switching element.

According to a sixth aspect of the disclosure, the inrush current prevention circuit according to the fifth aspect is such that the second comparator has hysteresis characteristics.

According to a seventh aspect of the disclosure, the inrush current prevention circuit according to the fifth or sixth aspect includes a delay circuit for delaying the output signal of the second comparator and applying the delayed output signal to the second switching element.

An eighth aspect of the disclosure is such that n (n is a plurality) of a parallel circuit of the high-resistance element and bypass element are connected in series between the power supply input terminal and load, the bypass threshold setting circuit or means sets voltages of n voltage dividing points in the voltage dividing circuit that divides the power supply voltage as n bypass thresholds, and each of n of the bypass elements is caused to operate when the output voltage exceeds each bypass threshold, thereby bypassing the high-resistance element connected in parallel with the relevant bypass element.

According to a ninth aspect of the disclosure, the inrush current prevention circuit according to any one the fifth to seventh aspect is such that n (n is a plurality) of a parallel circuit of the high-resistance element and bypass element are connected in series between the power supply input terminal and load, the bypass threshold setting circuit or means applies voltages of n voltage dividing points in the voltage dividing circuit to n of the second comparator one by one as n of the bypass threshold, and by each of n of the second switching element being turned on when the output voltage exceeds each bypass threshold, each of n of the bypass element is turned on, thereby bypassing the high-resistance element connected in parallel with the relevant bypass element.

According to embodiments of the disclosure, a bypass threshold (capacitor charging threshold) that forms a timing trigger for bypassing a high-resistance element such as a current limiting resistor is set in accordance with a voltage dividing ratio of a power supply voltage, because of which an excessive inrush current generated when the high-resistance element is bypassed can be prevented regardless of a rated input voltage range.

### BRIEF DESCRIPTION OF THE DRAWINGS

FIG. 1 is a circuit diagram showing a first embodiment of the disclosure.

FIG. 2 is a circuit diagram showing a second embodiment of the disclosure.

FIG. 3 is a circuit diagram showing a main portion of a third embodiment of the disclosure.

FIG. 4 is a circuit diagram showing existing technology described in JP '166.

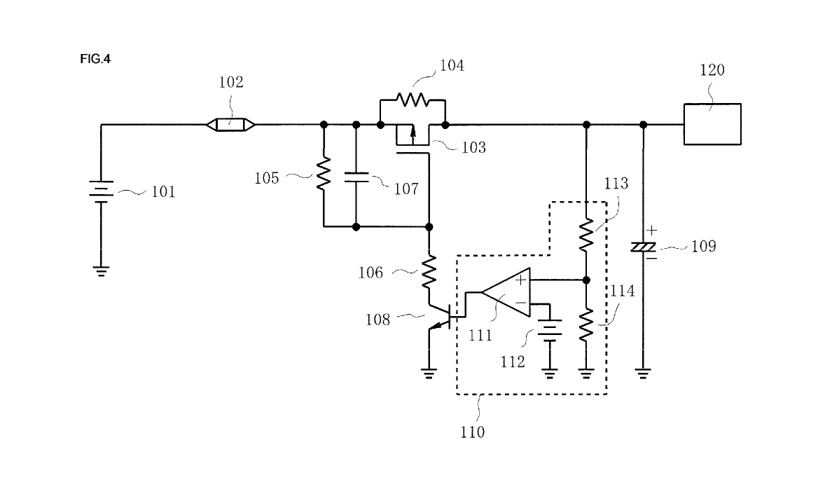

FIG. 5 is a circuit diagram showing existing technology described in JP '448.

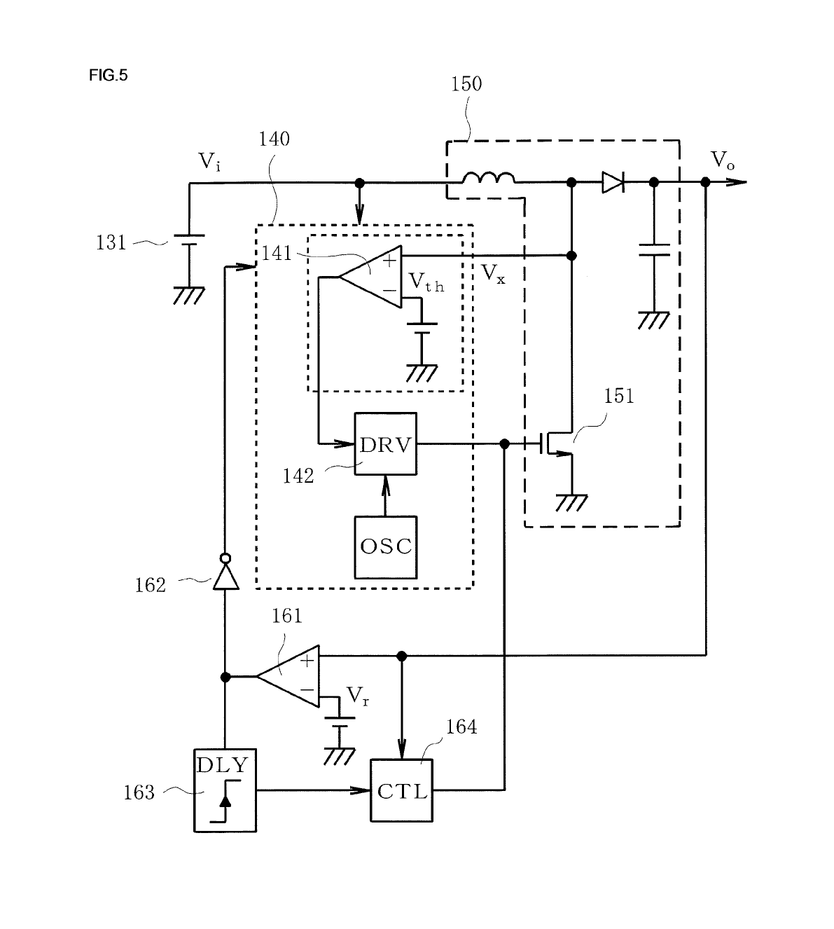

FIG. 6 is a circuit diagram showing existing technology described in JP '870.

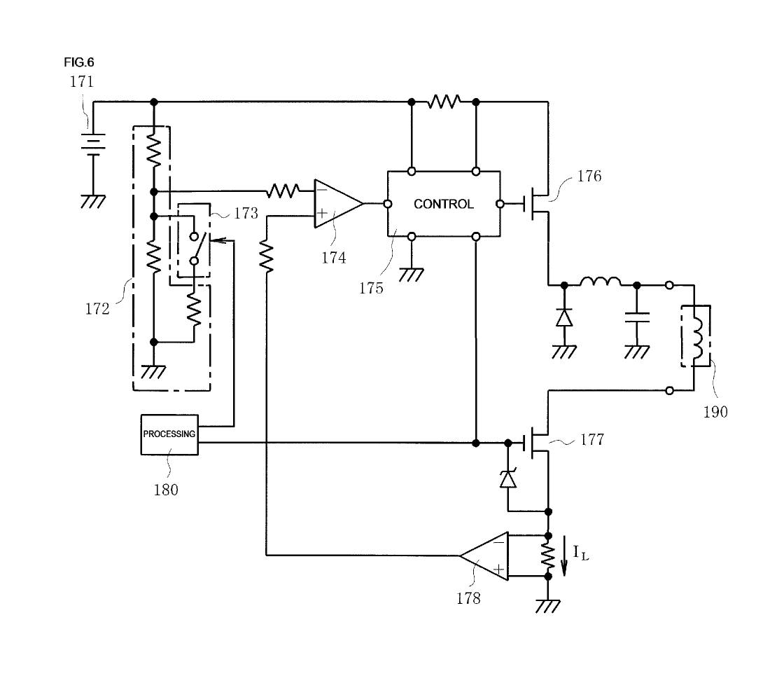

### DESCRIPTION OF EMBODIMENTS

Hereafter, based on the drawings, embodiments of the disclosure will be described.

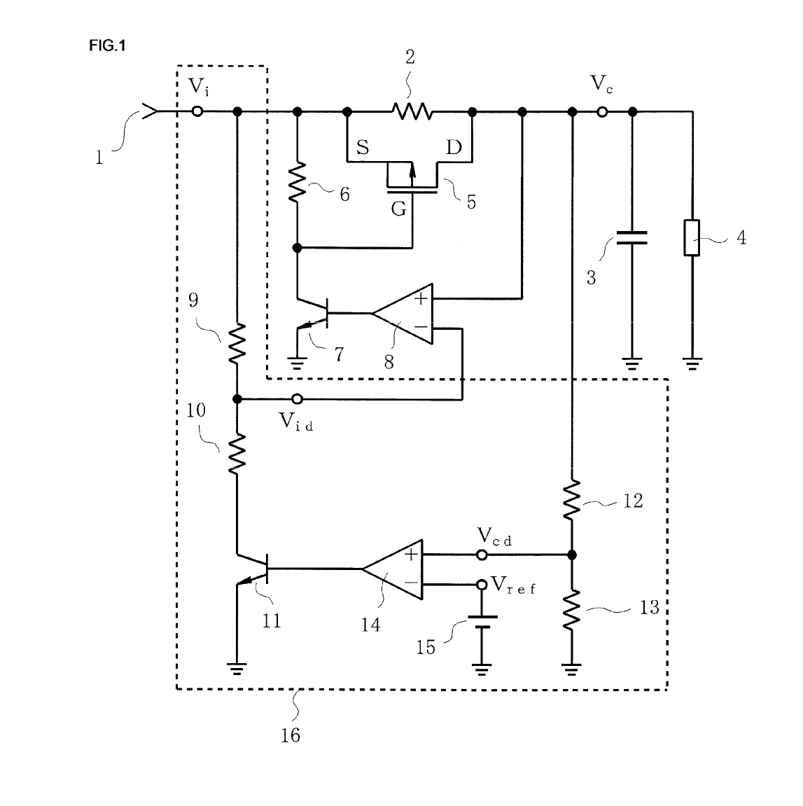

FIG. 1 shows an inrush current prevention circuit according to a first embodiment of the disclosure. In FIG. 1, one end of each of capacitor 3 and load 4 is connected via a current limiting resistor 2 acting as a high-resistance element to a power supply input terminal 1, to which a direct current power supply (not shown) is connected.

The two ends of the current limiting resistor 2 are connected one each to a source S and drain D of a P-type MOSFET (hereafter referred to simply as an FET) 5 acting as a bypass element (a bypass switching element). Also, a pull-up resistor 6 and a second switching element 7 are connected in series between the power supply input terminal 1 and a ground point, and a connection point of the two is connected to a gate G of the FET 5.

The switching element 7 is a bipolar transistor, and an output signal of a second comparator 8 is applied to a base of the switching element 7. A voltage (output voltage) V_{c} of one end of the capacitor 3 is applied to a positive input terminal of the comparator 8.

Meanwhile, resistors 9 and 10, which divide an input voltage (power supply voltage) Vᵢ, and a first switching element 11, which is a bipolar transistor, are connected in series between the power supply input terminal 1 and a ground point, and a connection point of the resistors 9 and 10, that is, a voltage dividing point, is connected to a negative input terminal of the comparator 8.

Also, resistors 12 and 13, which divide the output voltage V_{c}, are connected in series between one end of the capacitor 3 and a ground point, and a voltage (a value corresponding to the output voltage) V_{cd} of a voltage dividing point to which the resistors 12 and 13 are connected is applied to a positive input terminal of a first comparator 14. A reference voltage V_{ref} of a reference power supply 15 is applied to a negative input terminal of the comparator 14, and an output signal of the comparator 14 is applied to a base of the switching element 11.

Herein, reference code 16 is a bypass threshold setting circuit and is also an example of a bypass threshold setting means. Bypass threshold setting circuit 16 is formed of the voltage dividing resistors 9, 10, 12, and 13, the switching element 11, the comparator 14, and the reference power supply 15, and a main portion thereof can be configured of, for example, a generic IC.

The bypass threshold setting circuit 16 operates so that the input voltage Vᵢ is divided in accordance with the magnitude of the output voltage V_{c} by a voltage dividing circuit formed of the resistors 9 and 10, and a voltage V_{id} of the voltage dividing point of the resistors 9 and 10 is set as a threshold (bypass threshold) of the second comparator 8.

The second comparator 8 outputs a high level or low level signal in accordance with a result of comparing the voltage V_{c} of the capacitor 3 and a voltage set by the input voltage Vᵢ being divided by the resistors 9 and 10, that is, the bypass threshold V_{id}, thereby controlling the second switching element 7 on and off. The voltage dividing ratio of the resistors 9 and 10 is arbitrary, but in terms of restricting an inrush current when the FET 5 carries out a bypass operation, it is sufficient, taking resistance values of the resistors 9 and 10 to be R₉ and R₁₀ respectively, to select resistance values so that R₁₀/(R₉+R₁₀) is roughly in the region of 0.9 (90%).

The first comparator 14 outputs a high level or low level signal in accordance with a result of comparing the output voltage corresponding value V_{cd}, which is the voltage V_{c} of the capacitor 3 divided by the resistors 12 and 13, and the reference voltage V_{ref}, thereby controlling the first switching element 11 on and off. Herein, the voltage dividing ratio of the resistors 12 and 13 is desirably such that the switching element 11 can be turned on when the generated voltage V_{cd} corresponding to the voltage V_{c} is lower than a minimum operating voltage of the load 4.

Next, an operation of the first embodiment will be described.

When the power supply to the circuit is turned on and the input voltage Vᵢ is applied, charging of the capacitor 3 is started by a current whose magnitude is limited by the current limiting resistor 2. A magnitude relationship between the divided voltage value V_{cd} of the output voltage V_{c}, which gradually rises in accompaniment to the charging, and the reference voltage V_{ref} is such that the output signal of the comparator 14 is at a low level for a period for which V_{cd}≦V_{ref}, and the switching element 11 maintains an off-state.

Because of this, the voltage V_{id} of the negative input terminal of the comparator 8 is pulled up to the power supply input terminal 1 by the resistor 9, and becomes equivalent to the input voltage Vᵢ.

At this time, it is clear that Vᵢ>V_{c}, because of which V_{id}>V_{c}, the output signal of the comparator 8 is at a low level, and the switching element 7 is in an off-state. Because of this, the gate G of the FET 5 is pulled up to the input voltage Vᵢ by the resistor 6, because of which the gate G-to-source S voltage of the FET 5 becomes roughly 0V, and the FET 5 maintains an off-state.

Next, a description will be given of an operation when the charging of the capacitor 3 proceeds, and the voltage V_{c} rises to an extent that V_{cd}>V_{ref}.

In this case, as V_{cd}>V_{ref}, the output signal of the comparator 14 is at a high level, and the switching element 11 is in an on-state. Herein, provisionally taking a collector-emitter voltage of the switching element 11 to be 0V in order to facilitate understanding, the voltage V_{id} of the voltage dividing point of the resistors 9 and 10 is a value determined by the resistance values R₉ and R₁₀ of the resistors 9 and 10 respectively. For example, when taking the resistance value R₉ to be 1 kΩ and the resistance value R₁₀ to be 9 kΩ, voltage V_{id} that is 90% of the input voltage Vᵢ is applied to the negative input terminal of the comparator 8 as the bypass threshold.

The voltage V_{c} is input into the positive input terminal of the comparator 8, because of which, according to the heretofore described example of the resistance values R₉ and R₁₀, the output signal of the comparator 8 is at a low level, and the switching element 7 maintains an off-state, when V_{c} is 90% or less of Vᵢ. When V_{c} exceeds 90% of Vᵢ, the output signal of the comparator 8 inverts to a high level, and the switching element 7 switches to an on-state. When provisionally taking a collector-emitter voltage of the switching element 7 to be 0V in order to facilitate understanding, the gate G-to-source S voltage of the FET 5 is −VᵢV at this time, because of which the FET 5 is in an on-state, and the current limiting resistor 2 is bypassed.

For example, when the rated input voltage range is 5 to 15V and the ratio of the resistance values R₉ and R₁₀ is 1:9, the voltage V_{c} when the input voltage Vᵢ is 5V is 90% (4.5V) or more of the input voltage Vᵢ. Because of this, a potential difference across the current limiting resistor 2 (a drain D-to-source S voltage of the FET 5) when the FET 5 switches from an off-state to an on-state is at most 0.5V. Also, the voltage V_{c} when the input voltage Vᵢ is 15V is 90% (13.5V) or more of the input voltage Vᵢ, because of which, in the same way, the potential difference across the current limiting resistor 2 is at most 1.5V. Consequently, it does not happen that an excessive current flows into the capacitor 3 or load 4 when the FET 5 shifts to an on-state.

According to the first embodiment, as heretofore described, a bypass threshold that forms a condition triggering a bypass operation of the FET 5 can be set in accordance with a voltage division ratio of the input voltage Vᵢ, because of which an inrush current at a time of a bypass operation can be reliably restricted, even when the rated input voltage range is wide.

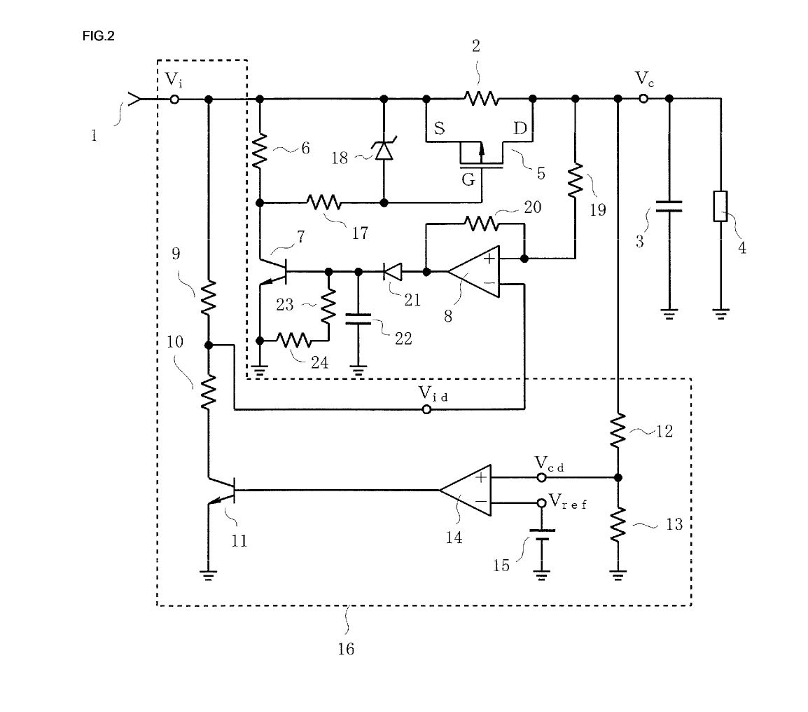

Next, based on FIG. 2, a description will be given of a second embodiment of the disclosure.

In FIG. 2, the same reference sign is allotted to a portion having the same function as in FIG. 1, and a description thereof omitted, and the description hereafter centers on a portion differing from FIG. 1.

In FIG. 2, a resistor 19 is connected between the drain D of the FET 5 and the positive input terminal of the comparator 8, and a resistor 20 is connected between the positive input terminal of the comparator 8 and an output terminal. The resistors 19 and 20 are for applying hysteresis characteristics to the comparator 8 in accordance with a ratio of resistance values of the resistors 19 and 20.

Also, a diode 21, capacitor 22, and resistors 23 and 24, which configure a delay circuit, are connected between the output terminal of the comparator 8 and the switching element 7.

Furthermore, a Zener diode 18 is connected with the polarity shown in the drawing between the source S and gate G of the FET 5, and a resistor 17 is connected between an anode of the Zener diode 18 and the collector of the switching element 7.

The Zener diode 18 has an application of protecting the FET 5 against an input overvoltage, while the resistor 17 has an application of protecting the Zener diode 18 when an input overvoltage is generated, and neither affects a main circuit operation of the disclosure.

In the first embodiment, a bypass threshold for the FET 5 to switch to an on-state is fixed only by a voltage division ratio based on the resistance values R₉ and R₁₀ of the resistors 9 and 10, but in the second embodiment, the resistors 19 and 20 are selected so that when resistance values of the resistors 19 and 20 are taken to be R₁₉ and R₂₀ respectively, {R₁₀/(R₉+R₁₀)}×{(R₁₉+R₂₀)/R₂₀} is roughly in the region of 0.9 (90%).

By hysteresis characteristics being applied to the comparator 8 by the resistors 19 and 20, concern that the FET 5 will repeat an on/off operation is reduced, even when, for example, the voltage V_{c} repeatedly fluctuates so as to straddle the bypass threshold due to the effect of noise or the like.

Furthermore, by the delay circuit formed of the diode 21, capacitor 22, and resistors 23 and 24 being provided on the output side of the comparator 8, an on-state of the FET 5 can be maintained and power supplied for a period for which the load 4 continues operating when, for example, the voltage V_{c} monotonically decreases to an extent that V_{cd}<V_{ref}.

Next, an operation of the second embodiment will be described.

Immediately after the power supply is turned on, an operation for a period for which the magnitude relationship between the divided voltage value V_{cd} of the voltage V_{c} and the reference voltage V_{ref} is V_{cd}<V_{ref} is the same as in the first embodiment, the output signal of the comparator 14 is at a low level, and the switching element 11 is in an off-state. Also, the voltage V_{id} of the negative input terminal of the comparator 8 is equivalent to the input voltage Vᵢ.

As Vᵢ>V_{c} at this time, V_{id}>V_{c}, the output signal of the comparator 8 is at a low level, and the switching element 7 is in an off-state. Therefore, the gate G of the FET 5 is pulled up to the input voltage Vᵢ by the resistors 17 and 6, and the gate G-to-source S voltage of the FET 5 becomes roughly 0V, because of which the FET 5 maintains an off-state.

Next, a description will be given of an operation when the charging of the capacitor 3 proceeds, and the voltage V_{c} rises to an extent that V_{cd}>V_{ref}.

When V_{cd}>V_{ref}, the output signal of the comparator 14 is at a high level, and the switching element 11 is in an on-state. Provisionally taking the collector-emitter voltage of the switching element 11 to be 0V, in the same way as in the first embodiment, the voltage V_{id} of the voltage dividing point is a voltage division value of the resistors 9 and 10. For example, when taking the resistance value R₉ of the resistor 9 to be 1 kΩ and the resistance value R₁₀ of the resistor 10 to be 3 kΩ, a voltage that is 75% of the input voltage Vᵢ is applied to the negative input terminal of the comparator 8 as the bypass threshold. In the event that the output signal of the comparator 8 inverts from a low level to a high level at this time, it is sufficient to reselect the resistance values R₉ and R₁₀ together with the resistance values R₁₉ and R₂₀ of the hysteresis resistors 19 and 20.

When the voltage V_{c} of the capacitor 3 rises further, and exceeds a voltage wherein the voltage that is 75% of the input voltage Vᵢ and the hysteresis voltage set by the resistors 19 and 20 are added together, the output signal of the comparator 8 inverts from a low level to a high level.

For example, when the resistance value R₁₉ is taken to be 8 kΩ and the resistance value R₂₀ is taken to be 4 kΩ, {R₁₀/(R₉+R₁₀)}×{(R₁₉+R₂₀)/R₂₀} is 0.9 (90%), because of which, when the voltage V_{c} of the capacitor 3 rises to or above 90% of the input voltage Vᵢ, the output signal of the comparator 8 inverts from a low level to a high level, the capacitor 22 in the delay circuit is charged via the diode 21, and the switching element 7 switches to an on-state. No charging resistor of the capacitor 22 is shown in FIG. 2, but when wishing to further delay an operation of turning on the FET 5, it is sufficient to insert a charging resistor having a predetermined resistance value between a cathode of the diode 21 and one end of the capacitor 22.

When the output signal of the comparator 8 switches to a high level and the switching element 7 shifts to an on-state, the gate G-to-source S voltage of the FET 5 is −VᵢV when provisionally taking the collector-emitter voltage of the switching element 7 to be 0V, in the same way as previously described, because of which the FET 5 is in an on-state, and the current limiting resistor 2 is bypassed.

In the second embodiment too, as heretofore described, a bypass threshold that forms a condition triggering a bypass operation of the FET 5 can be set in accordance with a voltage division ratio of the input voltage Vᵢ, because of which an inrush current at a time of a bypass operation can be reliably restricted, even when the rated input voltage range is wide.

Next, a description will be given of an operation in the second embodiment when the input voltage Vᵢ decreases.

When the input voltage Vᵢ is within the rated input range, the FET 5 is in an on-state, because of which the magnitude relationship between Vᵢ and V_{c}, although strictly speaking Vᵢ>V_{c}, is such that Vᵢ and V_{c} are roughly equal values. As the switching element 11 is also in an on-state at this time, the dividing point voltage V_{id} is always lower than the voltage V_{c} of the capacitor 3 within the rated input range.

Consequently, even when the input voltage Vᵢ decreases within the rated input range, the output signal of the comparator 8 does not invert from a high level to a low level, because of which the FET 5 maintains an on-state.

Herein, a minimum operating voltage is generally specified for a part corresponding to the load 4 in FIG. 2, but in actuality, the load 4 can operate even when a voltage slightly lower than the minimum operating voltage is applied. Because of this, when the voltage V_{c} decreases to an extent such as to fall under the rated input range of the load 4, it is necessary to avoid a situation wherein the FET 5 switches to an off-state despite the load 4 operating, and the delay circuit in FIG. 2 is provided in consideration of the above-mentioned point.

That is, when the voltage V_{c} decreases to an extent that, for example, V_{cd}<V_{ref}, the output signal of the comparator 14 inverts from a high level to a low level. By the switching element 11 switching to an off-state at this time, the input voltage Vᵢ is applied via the resistor 9 to the negative input terminal of the comparator 8.

As Vᵢ>V_{c}, as previously described, the output signal of the comparator 8 inverts from a high level to a low level, but by appropriately setting the values of the capacitor 22 and resistors 23 and 24 in the delay circuit, an on-state of the FET 5 can be held for a desired delay time, and a drive state of the load 4 can be maintained.

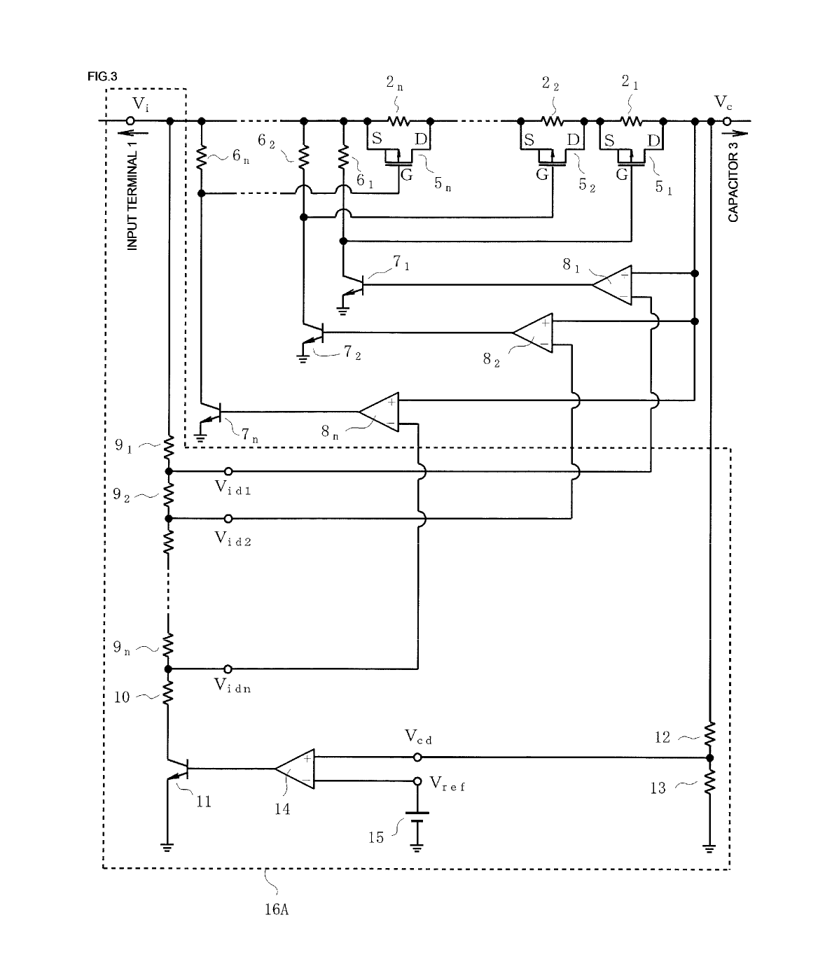

Next, FIG. 3 is a circuit diagram showing a main portion of a third embodiment of the disclosure.

The third embodiment envisages a case wherein the rated input voltage range is extremely wide, multiple stages of the second comparator 8, second switching element 7, current limiting resistor 2, and FET 5 of the first and second embodiments are provided, and an inrush current at a time of a bypass operation is restricted by the FETs 5 being sequentially turned on in accordance with the magnitude of the voltage V_{c} of the capacitor 3.

In FIG. 3, n (n is a multiple) current limiting resistors 2₁ to 2ₙ are connected in series between the power supply input terminal 1 and one end of the capacitor 3, and FETs 5₁ to 5ₙ are connected in parallel to the resistors 2₁ to 2ₙ respectively.

The drain D of the FET 5₁ on the capacitor 3 side is connected to each positive input terminal of n second comparators 8₁ to 8ₙ provided corresponding to the current limiting resistors 2₁ to 2ₙ, and each negative input terminal of the comparators 8₁ to 8ₙ is connected to a voltage dividing point between resistors in a series circuit of voltage dividing resistors 9₁ to 9ₙ and a resistor 10 connected between the power supply input terminal 1 and a ground point.

Also, output terminals of the second comparators 8₁ to 8ₙ are connected to bases of n second switching elements 7₁ to 7ₙ respectively, and collectors of the switching elements 7₁ to 7ₙ are connected via resistors 6₁ to 6ₙ to the source S of the FET 5ₙ. Also, emitters of the switching elements 7₁ to 7ₙ are all grounded.

Also, as a configuration of bypass threshold setting circuit 16A is the same as in the first and second embodiments except for the series circuit of voltage dividing resistors 9₁ to 9ₙ, a description thereof will be omitted here.

In the third embodiment, the FETs 5₁ to 5ₙ switch to an on-state in an order of 5ₙ to 5ₙ₋₁ and so on until 5₂ to 5₁ while the voltage V_{c} of the capacitor 3 gradually rises (while a gap between the input voltage Vᵢ and the voltage V_{c} decreases) after the power supply is turned on.

For example, when a ratio of a combined resistance value of the series circuit of resistors 9₁ to 9ₙ and a resistance value of the resistor 10 is 9:1, a voltage V_{idn} of a connection point of the resistors 9ₙ and 10 is 0.5V when the input voltage Vᵢ is 5V, and the voltage V_{idn} is applied to the negative input terminal of the comparator 8ₙ as the bypass threshold. Because of this, the output signal of the comparator 8ₙ switches to a high level at a point at which the voltage V_{c} of the capacitor 3 exceeds 0.5V, the switching element 7ₙ switches to an on-state, and the FET 5ₙ also switches to an on-state. At this point, the source S-to-drain D voltage of the FET 5ₙ is of an insignificant value.

Also, as voltages of voltage dividing points of the resistors 9₁ to 9ₙ and 10 increase in an order of V_{idn} to V_{idn-1} and so on until V_{id2} to V_{id1}, the comparator output signals switch to a high level in an order of 8ₙ to 8ₙ₋₁ and so on until 8₂ to 8₁ while the voltage V_{c} of the capacitor 3 rises, and the FETs also switch to an on-state in an order of 5ₙ to 5ₙ₋₁ and so on until 5₂ to 5₁.

That is, the current limiting resistors are bypassed in an order of 2ₙ to 2ₙ₋₁ and so on until 2₂ to 2₁ together with the rise of the voltage V_{c} of the capacitor 3, and all of the current limiting resistors 2₁ to 2ₙ are bypassed at a point at which the voltage V_{c} exceeds the voltage V_{id1} of the voltage dividing point of the resistors 9₁ and 9₂.

Consequently, by appropriately selecting the values of the voltage dividing resistors 9₁ to 9ₙ and 10, a potential difference across the series circuit of current limiting resistors 2₁ to 2ₙ when all of the current limiting resistors are bypassed can be reduced, and no excessive inrush current flows into the capacitor 3 or load 4.

When the input voltage Vᵢ is extremely large, each of the voltage dividing point voltages V_{id1} to V_{idn} also increases in accordance with the magnitude of the input voltage Vᵢ, but as the potential difference across the series circuit of current limiting resistors 2₁ to 2ₙ becomes a small value owing to the same kind of operation as when the input voltage Vᵢ is small, current flowing via the FETs 5₁ to 5ₙ is reduced by a bypass operation, and generation of an inrush current can be prevented.

In the third embodiment too, in the same way as in the second embodiment, the second comparators 8₁ to 8ₙ may be provided with hysteresis characteristics, and a delay circuit may be inserted between the second comparators 8₁ to 8ₙ and switching elements 7₁ to 7ₙ.

Embodiments of the disclosure can be utilized as various kinds of direct current power supply device wherein a range of rated input voltage from a power supply is wide, and which have an application of supplying direct current voltage of a predetermined magnitude to a load.

Inclusion in this disclosure of any characterization of any product or method of the related art does not imply or admit that such characterization was known in the prior art or that such characterization would have been appreciated by one of ordinary skill in the art at the time a claimed invention was made, even if the product or method itself was known in the prior art at the time of invention of the present disclosure. For example, if a related art document discussed in the foregoing sections of this disclosure constitutes prior art, the inclusion of any characterization of the related art document does not imply or admit that such characterization of the related art document was known in the prior art or would have been appreciated by one of ordinary skill in the art at the time a claimed invention was made, especially if the characterization is not disclosed in the related art document itself.

Although a few embodiments have been shown and described, it would be appreciated by those skilled in the art that changes may be made in these embodiments without departing from the principles and spirit of the invention, the scope of which is defined in the claims and their equivalents.

Reference signs and numerals are as follows:
1: Power supply input terminal
2, 2₁ to 2ₙ: Current limiting resistor
3: Capacitor
4: Load
5, 5₁ to 5ₙ: FET
7, 7₁ to 7ₙ, 11: Switching element
6, 6₁ to 6ₙ, 9, 9₁ to 9ₙ, 10, 12, 13, 17, 19, 20, 23, 24: Resistor
8, 8₁ to 8ₙ, 14: Comparator
15: Reference power supply
16, 16A: Bypass threshold setting circuit
18: Zener diode
21: Diode
22: Capacitor
G: Gate
S: Source
D: Drain

What is claimed is:

1. An inrush current prevention circuit comprising:
a power supply input terminal;
a high-resistance element to restrict an inrush current flowing in when a power supply voltage is applied to the power supply input terminal;
a low-resistance bypass element connected in parallel with the high-resistance element and configured to operate so as to cause current to bypass the high-resistance element when an output voltage being output from the inrush current prevention circuit to a load exceeds a bypass threshold; and
a bypass threshold setting circuit that divides the power supply voltage in accordance with the output voltage, and sets the bypass threshold in accordance with a voltage value of a voltage dividing point of the bypass threshold setting circuit.

2. The inrush current prevention circuit according to claim 1, wherein
the bypass threshold setting circuit includes:
a first comparator that compares a value corresponding to the output voltage and a first threshold;
a first switching element that operates in accordance with an output signal of the first comparator when the output voltage corresponding value exceeds the first threshold; and
a voltage dividing circuit that divides the power supply voltage in accordance with an operation of the first switching element, and
the voltage dividing point is in the voltage dividing circuit, and the value of the voltage dividing point is set as the bypass threshold when the output voltage corresponding value exceeds the first threshold.

3. The inrush current prevention circuit according to claim 2, wherein
the output voltage corresponding value is a voltage resulting from the output voltage to the load being divided, and
the first threshold is set in accordance with a lower limit value of a rated input voltage range.

4. The inrush current prevention circuit according to claim 2, wherein
the first threshold is set lower than a minimum operating voltage of the load.

5. The inrush current prevention circuit according to claim 3, wherein
the first threshold is set lower than a minimum operating voltage of the load.

6. The inrush current prevention circuit according to claim 2, further comprising:
a second comparator that compares the output voltage to the load and the bypass threshold; and
a second switching element that operates in accordance with an output signal of the second comparator when the output voltage exceeds the bypass threshold, wherein
the bypass element bypasses the high-resistance element in accordance with an operation of the second switching element.

7. The inrush current prevention circuit according to claim 3, further comprising:
a second comparator that compares the output voltage to the load and the bypass threshold; and
a second switching element that operates in accordance with an output signal of the second comparator when the output voltage exceeds the bypass threshold, wherein
the bypass element bypasses the high-resistance element in accordance with an operation of the second switching element.

8. The inrush current prevention circuit according to claim 4, further comprising:
a second comparator that compares the output voltage to the load and the bypass threshold; and
a second switching element that operates in accordance with an output signal of the second comparator when the output voltage exceeds the bypass threshold, wherein
the bypass element bypasses the high-resistance element in accordance with an operation of the second switching element.

9. The inrush current prevention circuit according to claim 5, further comprising:
a second comparator that compares the output voltage to the load and the bypass threshold; and
a second switching element that operates in accordance with an output signal of the second comparator when the output voltage exceeds the bypass threshold, wherein
the bypass element bypasses the high-resistance element in accordance with an operation of the second switching element.

10. The inrush current prevention circuit according to claim 6, wherein the second comparator has hysteresis characteristics.

11. The inrush current prevention circuit according to claim 7, wherein the second comparator has hysteresis characteristics.

12. The inrush current prevention circuit according to claim 8, wherein the second comparator has hysteresis characteristics.

13. The inrush current prevention circuit according to claim 9, wherein the second comparator has hysteresis characteristics.

14. The inrush current prevention circuit according to claim 6, comprising
a delay circuit to delay the output signal of the second comparator and to apply the delayed output signal to the second switching element.

15. The inrush current prevention circuit according to claim 7, comprising
a delay circuit to delay the output signal of the second comparator and to apply the delayed output signal to the second switching element.

16. The inrush current prevention circuit according to claim 8, comprising
a delay circuit to delay the output signal of the second comparator and to apply the delayed output signal to the second switching element.

17. The inrush current prevention circuit according to claim 10, comprising
a delay circuit to delay the output signal of the second comparator and to apply the delayed output signal to the second switching element.

18. The inrush current prevention circuit according to claim 1, wherein
n parallel circuits of the high-resistance element and bypass element are connected in series between the power supply input terminal and load, n being a plural number,
the bypass threshold setting circuit sets voltages of n voltage dividing points in the voltage dividing circuit that divides the power supply voltage as n bypass thresholds, and
for each of the n parallel circuits, the respective bypass element is caused to operate when the output voltage exceeds the respective bypass threshold, thereby bypassing the respective high-resistance element connected in parallel with the respective bypass element.

19. The inrush current prevention circuit according to claim 5, wherein
n parallel circuits of the high-resistance element and bypass element are connected in series between the power supply input terminal and load, n being a plural number,
the bypass threshold setting circuit sets voltages of n voltage dividing points in the voltage dividing circuit that divides the power supply voltage as n bypass thresholds, and
for each of the n parallel circuits, the respective bypass element is caused to operate when the output voltage exceeds the respective bypass threshold, thereby bypassing the respective high-resistance element connected in parallel with the respective bypass element.

20. The inrush current prevention circuit according to claim 6, wherein
n parallel circuits of the high-resistance element and bypass element are connected in series between the power supply input terminal and load, n being a plural number,
the second comparator is disposed as n second comparators,
the second switching element is disposed as n second switching elements, respectively configured to operate in accordance with output signals of the n second comparators, and respectively configured to operate the bypass elements of the n parallel circuits, the bypass threshold setting circuit applies voltages of n voltage dividing points in the voltage dividing circuit to the n second comparators respectively as n bypass thresholds, and
for each of the n parallel circuits, the respective bypass element is turned on by the respective second switching element being turned on when the output voltage exceeds the respective bypass threshold, thereby bypassing the respective high-resistance element connected in parallel with the respective bypass element.
